(19) United States
(12) Patent Application Publication
(10) Pub. No.: US 2024/0377047 A1
(43) Pub. Date: Nov. 14, 2024

(54) ARCHITECTURAL DECORATIVE TRIM ACCESSORIES FOR LUMINAIRES

(71) Applicant: SIGNIFY HOLDING B.V., EINDHOVEN (NL)

(72) Inventors: Ramanand Radhakrishna KAMATH, PEACHTREE CITY, GA (US); WEI ZHAO, SHANGHAI (CN); JOSHUA SUTTLE, ATLANTA, GA (US); ZHIHONG LIN, SHANGHAI (CN); ADAM RUSSELL GREEN, NEWNAN, GA (US)

(21) Appl. No.: 18/291,663

(22) PCT Filed: Jul. 19, 2022
(86) PCT No.: PCT/EP2022/070150

§ 371 Date: Jan. 24, 2024

Related U.S. Application Data
(60) Provisional application No. 63/226,571, filed on Jul. 28, 2021.

(30) Foreign Application Priority Data
Aug. 6, 2021 (EP) 21190022.0

(51) Int. Cl. F21V 17/14; F21S 8/02

(52) U.S. Cl. CPC F21V 17/14; F21S 8/026

(57) ABSTRACT

A detachable trim accessory assembly (150) for a luminaire (100), the detachable trim accessory comprising: a trim adapter (130) comprising a trim collar (434) and a plurality of trim ring coupling features (435) disposed on the trim collar (434); and a trim ring (110) comprising a trim ring collar (513) and a plurality of trim adapter coupling features (515) disposed on the trim ring collar (513), wherein the plurality of trim adapter coupling features (515) is removably coupled to the plurality of trim ring coupling features (435) of the trim adapter (130).

### TECHNICAL FIELD

The present disclosure relates generally to recessed luminaires, and more particularly to systems, methods, and devices for architectural decorative trim accessories for luminaires.

### BACKGROUND

Recessed luminaires are mostly hidden from view once installed, with most of a recessed luminaire being positioned above a ceiling or other part of a structure. However, the bottom or distal end of a recessed luminaire is visible. Often, the visible part of a recessed luminaire is the trim. A user may want to have a trim with certain characteristics (e.g., shape, size, color). However, changing out a trim for an installed luminaire can be cumbersome and require the recessed luminaire to be uninstalled, which results in the time consuming, destructive, and labor-intensive process of ripping down and repairing the ceiling.

### SUMMARY

In general, in one aspect, the disclosure relates to a detachable trim assembly for a luminaire that includes a trim adapter comprising a trim collar and a plurality of trim ring coupling features disposed on the trim collar. The detachable trim accessory assembly can also include a trim ring comprising a trim ring collar and a plurality of trim adapter coupling features disposed on the trim ring collar, where the plurality of trim adapter coupling features is removably coupled to the plurality of trim ring coupling features of the trim adapter.

In another aspect, the disclosure relates to a luminaire that includes a trim comprising a trim body and a trim flange, where the trim flange is disposed at a distal end of the trim body. The luminaire can also include a detachable trim accessory assembly removably coupled to the trim, wherein the detachable trim accessory assembly comprises a trim adapter comprising a trim adapter body and a plurality of securing member assemblies disposed on the trim adapter body, wherein each of the plurality of securing member assemblies is configured to secure the trim adapter body against the trim flange.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIGS. 1A through 1C show various views of an installed recessed luminaire according to certain example embodiments.

FIGS. 2A through 2C show various views of the trim of the recessed luminaire of FIGS. 1A through 1C.

FIGS. 3A through 3D show various views of the detachable trim assembly of the recessed luminaire of FIGS. 1A through 1C.

FIGS. 4A through 4G show various views of the trim adapter of the detachable trim assembly of FIGS. 3A through 3D.

FIGS. 5A through 5D show various views of the trim ring of the detachable trim assembly of FIGS. 3A through 3D.

FIGS. 6 and 7 show light distributions within various trim rings according to example embodiments.

FIG. 8 shows part of a recessed luminaire that includes another detachable trim assembly according to certain example embodiments.

### DETAILED DESCRIPTION

In general, example embodiments provide systems, methods, and devices for architectural decorative trim accessories for luminaires. Example embodiments can provide a number of benefits. Such benefits can include, but are not limited to, fewer parts to keep in inventory, avoidance of added costs (e.g., material damage and repair) when changing portions of a trim, modularity, user control, and flexible light dispersion. Example embodiments can be used with new luminaires or retrofit with existing luminaires. Luminaires can include light fixtures, lighting devices, and/or lighting systems. While example embodiments described herein are directed to recessed luminaires, example embodiments can be used with any other type of luminaire, including but not limited to pendent lights, table lamps, troffers, and ceiling fan lights.

The term architectural used herein to describe example trim accessories is meant to convey that example embodiments (or portions thereof) can be functional, aesthetic, or a combination thereof. As discussed above, a recessed luminaire has at least a portion of the luminaire hidden from view by a structure (e.g., a ceiling tile, drywall), while a remainder of the recessed luminaire is visible in a volume of space in which the recessed luminaire provides illumination. Example embodiments can also be used with luminaires that are more visible by a user in a volume of space.

Luminaires with example architectural decorative trim accessories can be located in one or more of any of a number of environments. Examples of such environments can include, but are not limited to, indoors, outdoors, a parking garage, a kitchen or cooking space, a hallway, an entertainment room, an office space, a manufacturing plant, a warehouse, and a storage facility, either climate-controlled or non-climate-controlled. In some cases, the example embodiments discussed herein can be used in any type of hazardous environment, including but not limited to an airplane hangar, a drilling rig (as for oil, gas, or water), a production rig (as for oil or gas), a refinery, a chemical plant, a power plant, a mining operation, a wastewater treatment facility, and a steel mill.

Luminaires with example architectural decorative trim accessories can be integrated into any of a number of different structures. Such structures can include, but are not limited to, a pole, an I-beam, drywall, wood studs, a tree, a wall, and a building facade. A user may be any person that interacts with luminaires. Examples of a user may include, but are not limited to, an engineer, an electrician, an instrumentation and controls technician, a mechanic, an operator, a property manager, a homeowner, a tenant, an employee, a consultant, a contractor, and a manufacturer's representative.

Luminaires with example architectural decorative trim accessories (including components thereof) can be made of one or more of a number of suitable materials to allow the luminaire to meet certain standards and/or regulations while also maintaining durability in light of the one or more conditions under which the luminaires and/or other associated components of the luminaire can be exposed. Examples of such materials can include, but are not limited to, aluminum, stainless steel, fiberglass, glass, plastic, polymer, ceramic, and rubber.

Example architectural decorative trim accessories, or portions thereof, described herein can be made from a single piece (as from a mold, injection mold, die cast, or extrusion process). In addition, or in the alternative, example architectural decorative trim accessories can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, snap fittings, and slotted fittings. One or more pieces that are mechanically coupled to each other can be coupled to each other in one or more of a number of ways, including but not limited to fixedly, hingedly, removeably, slidably, and threadably.

Components and/or features described herein can include elements that are described as coupling, fastening, securing, abutting against, in communication with, or other similar terms. Such terms are merely meant to distinguish various elements and/or features within a component or device and are not meant to limit the capability or function of that particular element and/or feature. For example, a feature described as a “coupling feature” can couple, secure, fasten, abut against, and/or perform other functions aside from merely coupling.

A coupling feature (including a complementary coupling feature) as described herein can allow one or more components and/or portions of an example architectural decorative trim accessories to become coupled, directly or indirectly, to a structure (e.g., a pole), a housing of a luminaire, and/or some other component of the architectural decorative trim accessories. A coupling feature can include, but is not limited to, a clamp, a portion of a hinge, an aperture, a recessed area, a protrusion, a hole, a slot, a tab, a detent, and mating threads. One portion of an example architectural decorative trim accessories can be coupled to a structure, a housing of a luminaire, a frame of a luminaire, and/or some other component of the architectural decorative trim accessories by the direct use of one or more coupling features.

In addition, or in the alternative, a portion of an example architectural decorative trim accessories can be coupled to a structure, a housing of a luminaire, a frame of a luminaire, and/or some other component of the architectural decorative trim accessories using one or more independent devices that interact with one or more coupling features disposed on a component of the architectural decorative trim accessories. Examples of such devices can include, but are not limited to, a pin, a hinge, a fastening device (e.g., a bolt, a screw, a rivet), epoxy, glue, adhesive, and a spring. One coupling feature described herein can be the same as, or different than, one or more other coupling features described herein. A complementary coupling feature as described herein can be a coupling feature that mechanically couples, directly or indirectly, with another coupling feature.

In the foregoing figures showing example embodiments of architectural decorative trim accessories for luminaires, one or more of the components shown may be omitted, repeated, and/or substituted. Accordingly, example embodiments of architectural decorative trim accessories for luminaires should not be considered limited to the specific arrangements of components shown in any of the figures. For example, features shown in one or more figures or described with respect to one embodiment can be applied to another embodiment associated with a different figure or description.

In certain example embodiments, luminaires having example architectural decorative trim accessories are subject to meeting certain standards and/or requirements. For example, the National Electric Code (NEC), the National Electrical Manufacturers Association (NEMA), the International Electrotechnical Commission (IEC), the Federal Communication Commission (FCC), Underwriters Laboratories (UL), and the Institute of Electrical and Electronics Engineers (IEEE) set standards as to electrical enclosures, wiring, and electrical connections. Use of example embodiments described herein meet (and/or allow the luminaire to meet) such standards when applicable.

If a component of a figure is described but not expressly shown or labeled in that figure, the label used for a corresponding component in another figure can be inferred to that component. Conversely, if a component in a figure is labeled but not described with respect to that figure, the description for such component can be substantially the same as the description for a corresponding component in another figure. The numbering scheme for the various components in the figures herein is such that each component is a three-digit number, and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of architectural decorative trim accessories for luminaires will be described more fully hereinafter with reference to the accompanying drawings, in which example embodiments of architectural decorative trim accessories for luminaires are shown. Architectural decorative trim accessories for luminaires may, however, be embodied in many different forms and should not be construed as limited to the example embodiments set forth herein. Rather, these example embodiments are provided so that this disclosure will be thorough and complete, and will fully convey the scope of architectural decorative trim accessories for luminaires to those of ordinary skill in the art. Like, but not necessarily the same, elements (also sometimes called components) in the various figures are denoted by like reference numerals for consistency.

Terms such as “first”, “second”, “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. Such terms are not meant to denote a preference or a particular orientation. Such terms are not meant to limit embodiments of architectural decorative trim accessories for luminaires. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

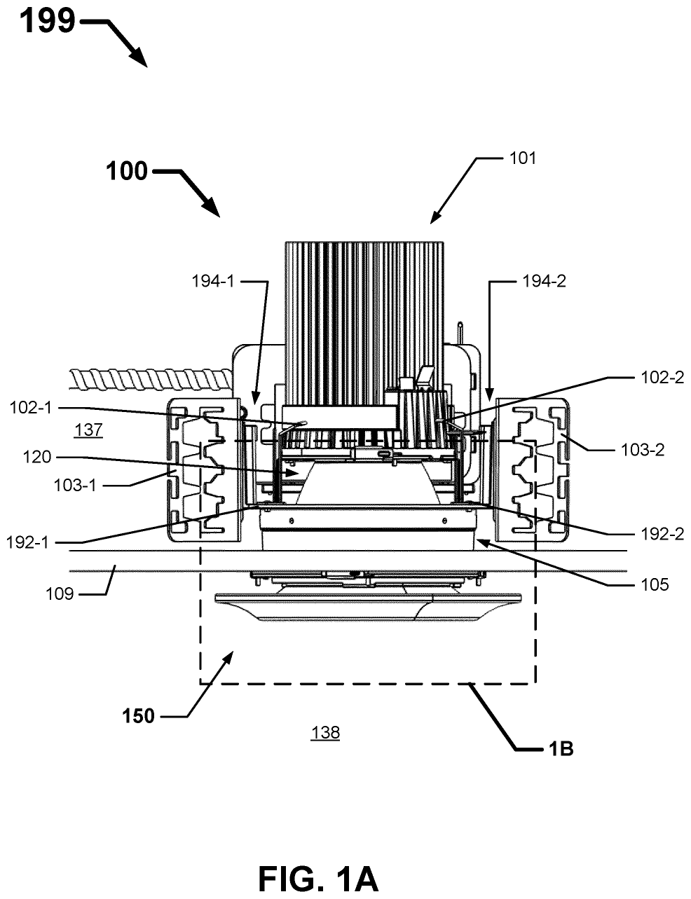

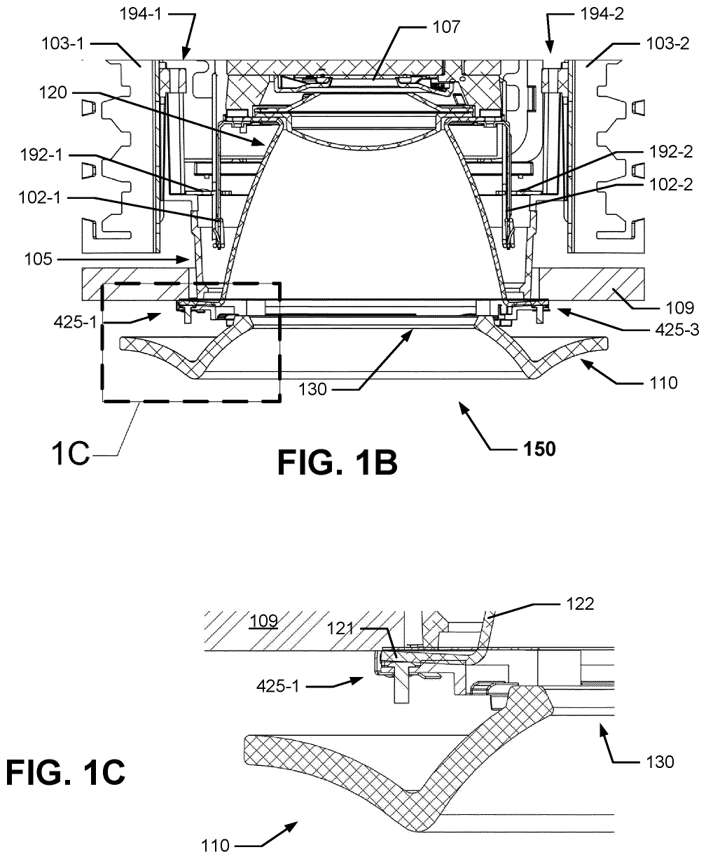

FIGS. 1A through 1C show various views of a system 199 that includes a recessed luminaire 100 according to certain example embodiments. Specifically, FIG. 1A shows a side view of the system 199. FIG. 1B shows a sectional side view of part of the recessed luminaire 100 of the system 199 of FIG. 1A. FIG. 1C shows a detailed view of the recessed luminaire 100 from FIG. 1B. The recessed luminaire 100 of the system 199 of FIGS. 1A through 1C is installed by being disposed in an aperture in a structure 109 (in this case, a ceiling). As a result, most of the recessed luminaire 100 is positioned in a volume of space 137 (e.g., a plenum space) above the structure 109, while the remainder of the recessed luminaire 100 is in a different volume of space 138 below the structure 109.

The recessed luminaire 100 includes a frame 105, a trim 120, a detachable trim accessory assembly 150, a heat sink assembly 101, one or more light sources 107, a pair of torsion spring receiver bracket assemblies 194 (torsion spring receiver bracket assembly 194-1 and torsion spring receiver bracket assembly 194-2), a pair of torsion springs 102 (torsion spring 102-1 and torsion spring 102-2), and a pair of mounting brackets 103 (mounting bracket 103-1 and mounting bracket 103-2).

The heat sink assembly 101 can serve multiple functions. For example, the heat sink assembly 101 can include an internal cavity inside of which can be housed one or more electrical components, including but not limited to a power supply (e.g., a driver) and a controller. As another example, the heat sink assembly 101 can include heat sinking material (e.g., thermally conductive metal) configured in such a way (e.g., multiple fins) to absorb heat generated by one or more heat-generating components (e.g., a driver) and dissipate the heat into the adjacent environment 137 (e.g., a plenum space).

The recessed luminaire 100 can include one or more light sources 107. Each light source 107 is configured to emit light, directly or indirectly, into the volume of space 138. In many cases, a light source 107 can provide general illumination into the volume of space 138. In alternative cases, a light source 107 can provide any of a number of other types of illumination (e.g., accent lighting, indirect lighting, task lighting) into the volume of space 138. A light source 107 can use any type of lighting technology, including but not limited to light-emitting diodes (LEDs), incandescent, halogen, fluorescent, and sodium vapor.

Each of the torsion spring receiver bracket assemblies 194 includes a torsion spring receiver bracket 192. In this case, the torsion spring receiver bracket assembly 194-1 includes the torsion spring receiver bracket 192-1, and the torsion spring receiver bracket assembly 194-2 includes the torsion spring receiver bracket 192-2. Each torsion spring receiver bracket 192 is configured to receive a torsion spring 102. In this case, the torsion spring receiver bracket 192-1 receives the torsion spring 102-1, and the torsion spring receiver bracket 192-2 receives the torsion spring 102-2. The torsion springs 102 are configured to help secure the recessed luminaire 100 within the volume of space 137 (e.g., a plenum space) above the structure 109.

Each mounting bracket 103 is mounted to an outer surface of a torsion spring receiver bracket assembly 194. For example, in this case, the mounting bracket 103-1 is mounted on the outer surface of the torsion spring receiver bracket assembly 194-1, and the mounting bracket 103-2 is mounted on the outer surface of the torsion spring receiver bracket assembly 194-2. The mounting brackets 103 are configured to help secure the recessed luminaire 100 within the volume of space 137 above the structure 109.

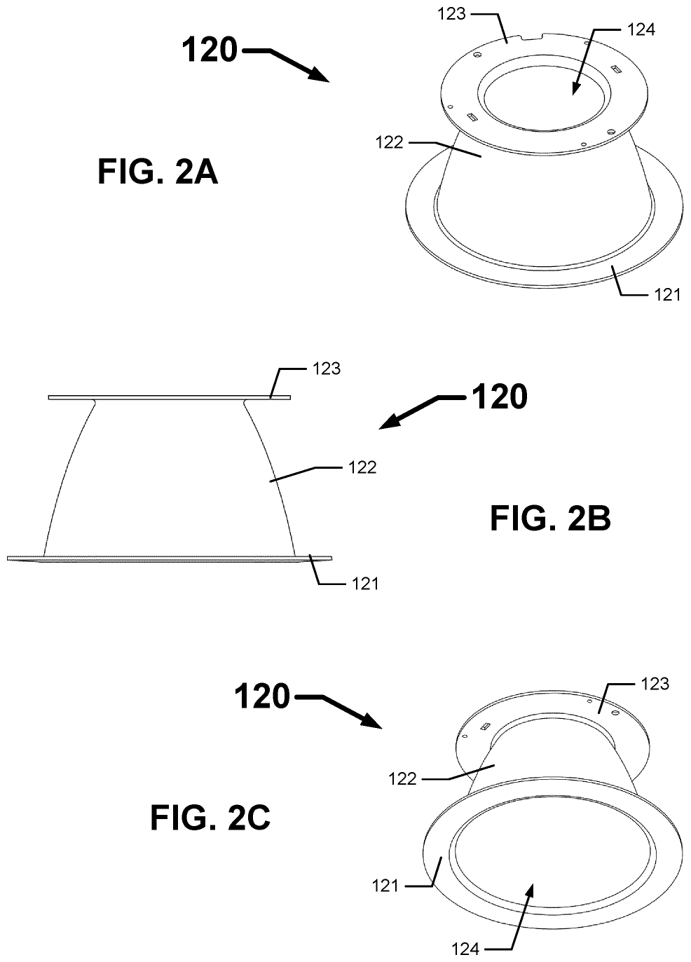

The trim 120 has a trim body 122 and a trim flange 121 that is disposed at the bottom (distal) end of the trim body 122. The trim flange 121 of the trim 120 is configured to be disposed in the volume of space 138 in which light from the recessed luminaire 100 is directed, and the remainder of the trim 120 is disposed in the volume of space 137 located above the structure 109. More details of the trim 120 is provided below with respect to FIGS. 2A through 2C.

The example detachable trim accessory assembly 150 of FIGS. 1A through 1C can include one or more of any number of components. For instance, in this case, the example detachable trim accessory assembly 150 (also sometimes more simply referred to as the detachable trim accessory 150) includes a trim adapter 130 and a trim ring 110 that are coupled to each other. The detachable trim accessory assembly 150 is coupled to the trim flange 121 of the trim 120, where the trim flange 121 is disposed in the volume of space 138. In alternative embodiments, other components (e.g., a housing, a frame, the heat sink assembly 101) of the luminaire 100 or a differently configured luminaire can be used to couple to the detachable trim accessory assembly 150.

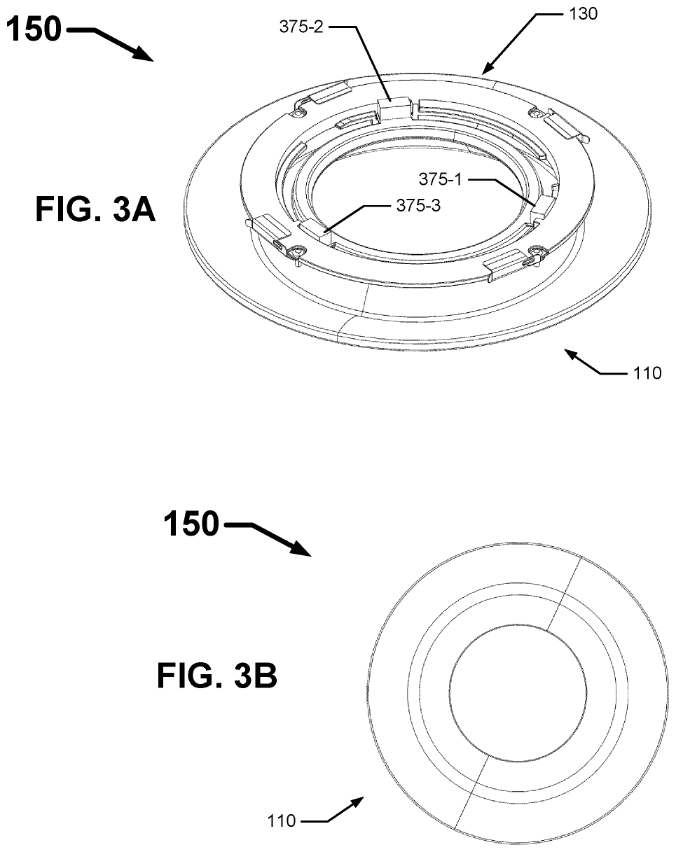

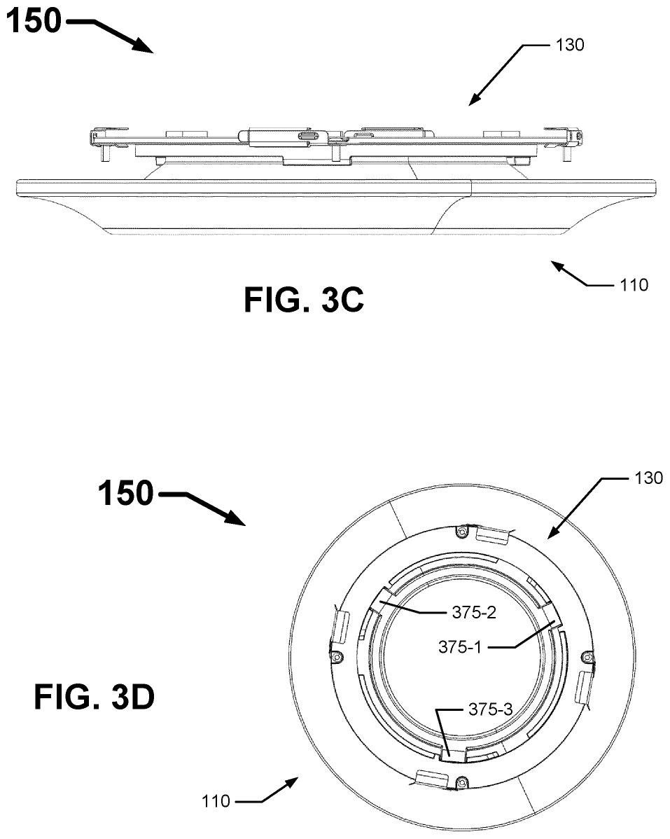

The detachable trim accessory assembly 150 can be coupled to and decoupled from the trim flange 121 of the trim 120 in any of a number of ways. For example, in this case, a number of securing member assemblies 425 (e.g., securing member assembly 425-1, securing member assembly 425-3) are used to secure the detachable trim accessory assembly 150 against the trim 120. More details about the detachable trim accessory assembly 150 are discussed below with respect to FIGS. 3A through 5D. The entirety of the detachable trim accessory assembly 150, when coupled to the trim flange 121, is configured to be disposed in the volume of space 138 in which light from the recessed luminaire 100 is directed.

Once the recessed luminaire 100 is installed, trying to make adjustments (e.g., modify the trim 120, change the orientation of the recessed luminaire 100) to the recessed luminaire 100 can be a destructive process in terms of the structure 109 (e.g., cut away and patch drywall) and/or in terms of one or more components (e.g., strip a screw or other fastening device, bend a torsion spring 102) of the recessed luminaire 100. This process also expends extra time and labor. Use of the example detachable trim accessory assembly 150 avoids these issues.

FIGS. 2A through 2C show various views of the trim 120 of the recessed luminaire 100 of FIGS. 1A through 1C. Specifically, FIG. 2A shows a top perspective view of the trim 120. FIG. 2B shows a side view of the trim 120. FIG. 2C shows a bottom perspective view of the trim 120. Referring to FIGS. 1A through 2C, the trim 120 of the recessed luminaire 100 can have any of a number of configurations. For example, as in this case and as discussed above, the trim 120 can have a trim body 122 and a trim flange 121 that extends outward from the trim body 122 at the bottom (distal end) of the trim body 122. In addition, the trim 120 of FIGS. 2A through 2C has another trim flange 123 that extends outward from the trim body 122 at the top (proximal end) of the trim body 122.

The trim body 122 of the trim 120 can have one or more walls that form any of a number of shapes. For example, in this case, the trim body 122 has one wall having a conical shape, where the diameter at the top (formed by trim flange 123) is smaller than the diameter at the bottom (formed by trim flange 121) of the trim body 122. The wall of the trim body 122 forms a cavity 124 that traverses the entire height (between the trim flange 121 and the trim flange 123) of the trim body 122.

The trim flange 123 can include one or more features (e.g., apertures, recesses, notches) that can be used for coupling the trim flange 123 to one or more other components (e.g., the heat sink assembly 101, a lens, a light source array) of the recessed luminaire 100. In this case, the trim flange 123 has a number of apertures that traverse the trim flange 123 and a notch cut out of part of the outer perimeter of the trim flange 123. Similarly, the trim flange 121 can include one or more features (e.g., apertures, detents, recesses) that can be used for coupling the trim flange 121 to one or more other components (e.g., the trim adapter 130) of the recessed luminaire 100. In this case, the trim flange 121 is planar and has no such features.

FIGS. 3A through 5D show various views of the detachable trim accessory assembly 150 (including components thereof) of the recessed luminaire 100 of FIGS. 1A through 1C. In particular, FIGS. 3A through 3D shows various views of an assembled detachable trim accessory assembly 150. Specifically, FIG. 3A shows a top perspective view of the detachable trim accessory assembly 150. FIG. 3B shows a bottom view of the detachable trim accessory assembly 150. FIG. 3C shows a side view of a portion of the detachable trim accessory assembly 150. FIG. 3D shows a top view of the detachable trim accessory assembly 150.

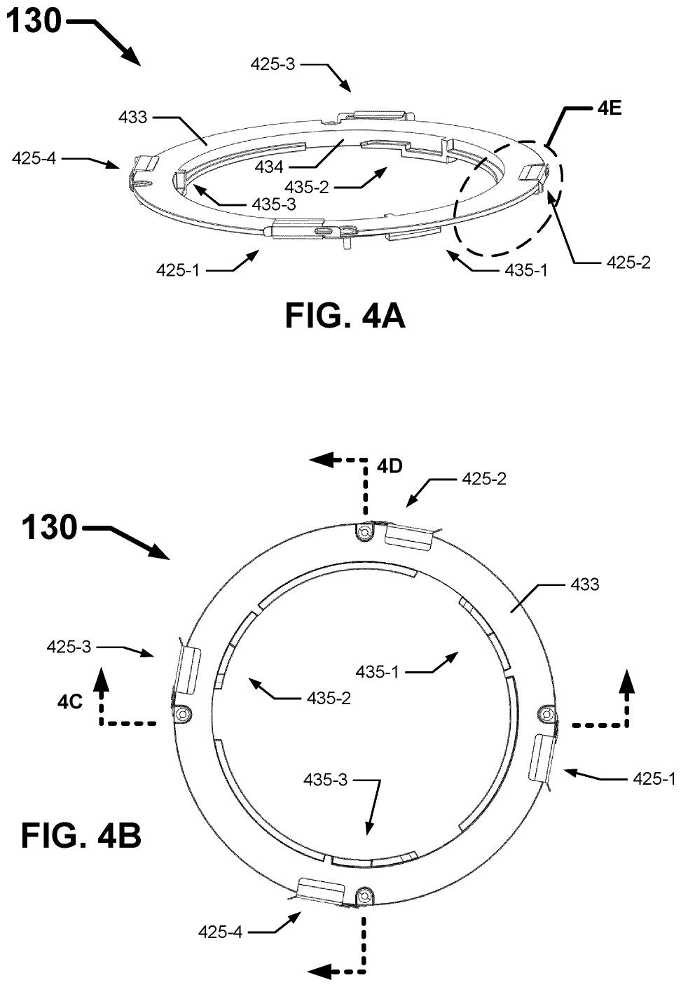

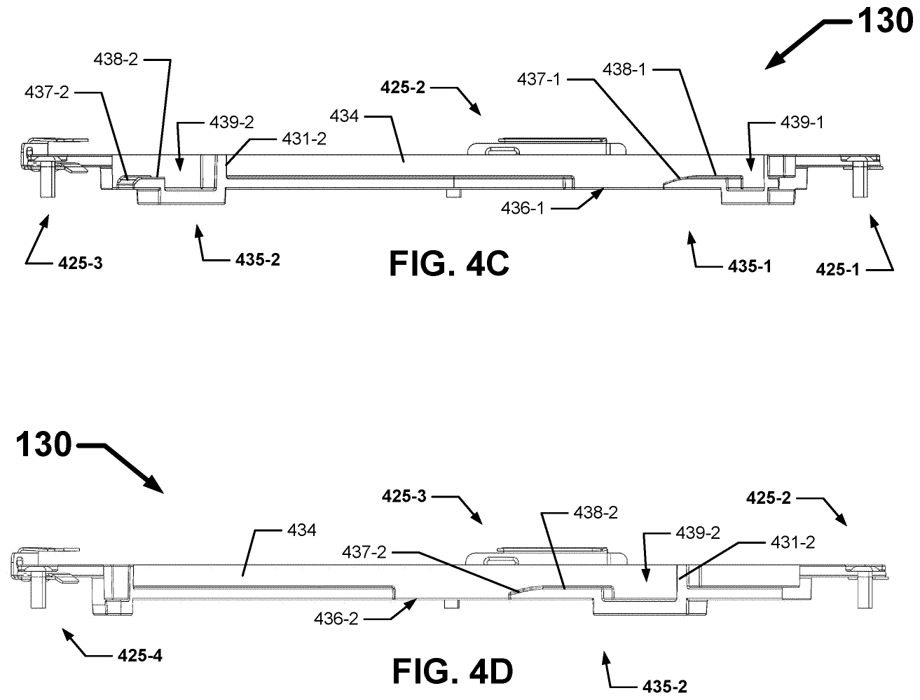

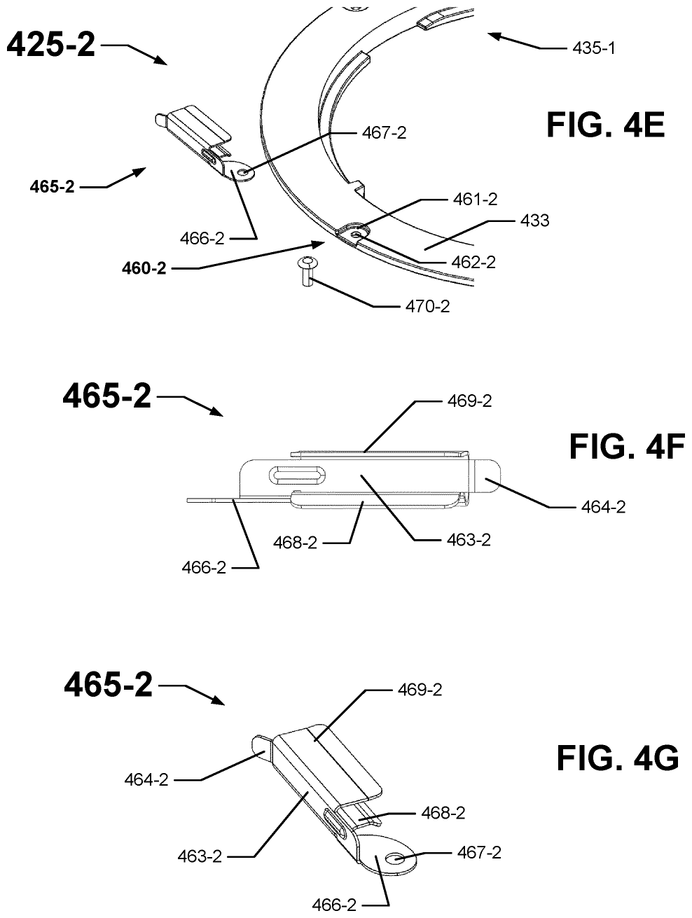

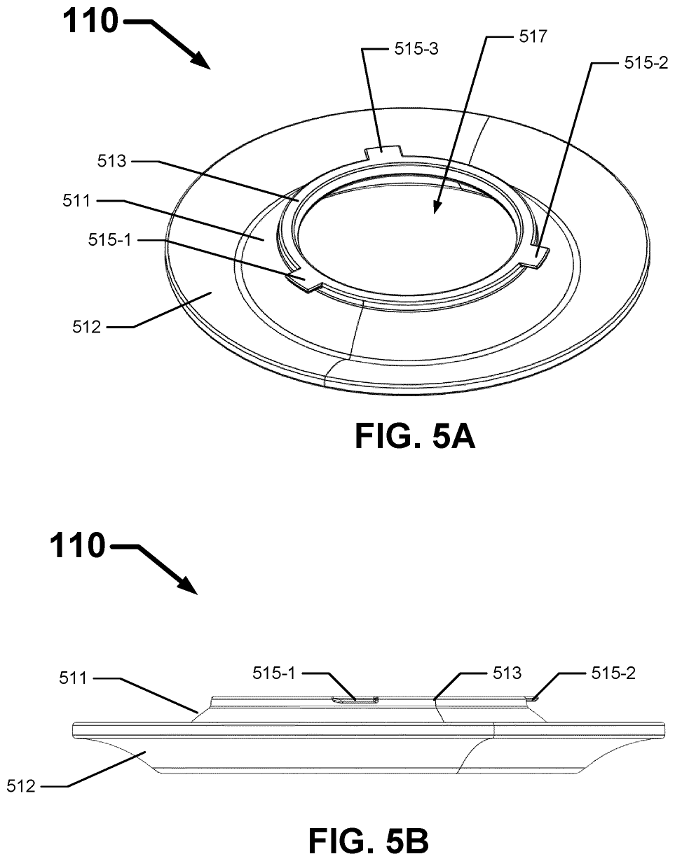

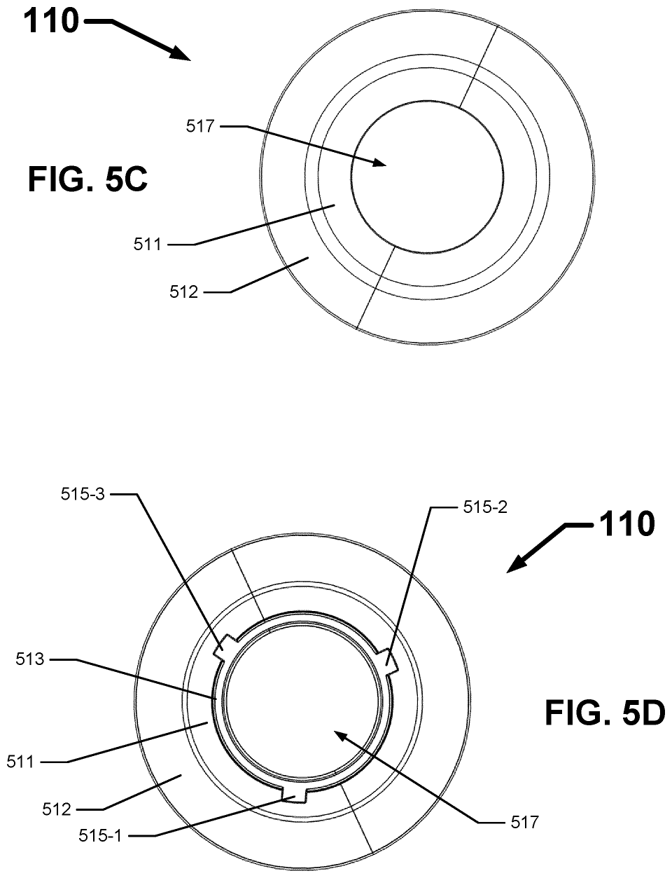

FIGS. 4A through 4G show various views of the trim adapter 130 of the detachable trim accessory assembly 150 of FIGS. 3A through 3D. Specifically, FIG. 4A shows a top perspective view of the trim adapter 130. FIG. 4B shows a top view of the trim adapter 130. FIGS. 4C and 4D each shows a sectional side view of the trim adapter 130. FIG. 4E shows a securing member assembly 425-2 of the trim adapter 130. FIGS. 4F and 4G show a rear view and a perspective view, respectively, of the securing member 465-2 of the securing member assembly 425-2. FIGS. 5A through 5D show various views of the trim ring 110 of the detachable trim accessory assembly 150 of FIGS. 3A through 3D. Specifically, FIG. 5A shows a top perspective view of the trim ring 110. FIG. 5B shows a side view of the trim ring 110. FIG. 5C shows a bottom view of the trim ring 110. FIG. 5D shows atop view of the trim ring 110.

Referring to FIGS. 1 through 5D, the detachable trim accessory assembly 150 of the recessed luminaire 100 can include multiple components. For example, in this case, as shown in FIGS. 3A through 3D, the detachable trim accessory assembly 150 includes the trim adapter 130 (as detailed in FIGS. 4A through 4G) and the trim ring 110 (as detailed in FIGS. 5A through 5D). These various components of the trim accessory assembly 150 can be directly or indirectly coupled to each other in any of a number of ways. For example, in this case, the trim adapter 130 and the trim ring 110 are directly and rotatably coupled to each other.

The trim adapter 130 can have any of a number of configurations. For example, in this case, as shown in FIGS. 4A through 4D, the trim adapter 130 has a body 433 (sometimes called a trim adapter body 433) and a collar 434 (sometimes called a trim adapter collar 434) that extends laterally downward from the inner edge of the body 433. The trim adapter 130 (or portions thereof) can have any of a number of general shapes and/or sizes. In certain example embodiments, the body 433 of the trim adapter 130 has certain characteristics (e.g., shape, size) that allow the securing member assemblies 425 to provide a coupling mechanism between the body 433 of the trim adapter 130 and the trim flange 121 of the trim 120. In this case, the body 433 of the trim adapter 130 is toroidal in shape (with a thin substantially rectangular profile as a cross-sectional shape) and has an inner and an outer diameter that are substantially the same as the inner and outer diameters of the trim flange 121 of the trim 120. Also, in this case, the collar 434 is generally cylindrical (allowing for the coupling features 435, discussed below) with a short height.

In certain example embodiments, the trim adapter 130 has a number (e.g., two, three (as in this case), five) of coupling features 435 (sometimes called the trim ring coupling features 435) that are configured to couple to complementary coupling features (in this case, the coupling features 515, discussed below) of the trim ring 110. Each coupling feature 435 can be disposed at any location with respect to the trim adapter 130. For example, in this case, all three coupling features 435 are disposed on the inner surface of the collar 434 of the trim adapter 130.

When there are multiple coupling features 435, one coupling feature 435 (e.g., coupling feature 435-2) can have the same or a different configuration (e.g., shape, size, coupling mechanism) as the other coupling features 435. In this example, all three coupling features 435 (coupling feature 435-1, coupling feature 435-2, and coupling feature 435-3) have the same configuration as each other in the form of a type of slot. Also, when there are multiple coupling features 435 disposed on the trim adapter 130, the coupling features 435 can be spaced in any of a number of ways (e.g., equidistantly (as in this case), randomly) with respect to each other.

Each of the coupling features 435 of the trim adapter 130 can have multiple components. Specifically, as shown in FIGS. 4C and 4D, each coupling feature 435 includes an entry space 436 (as shown by entry space 436-1 in FIG. 4C for coupling feature 435-1 and entry space 436-2 in FIG. 4D for coupling feature 435-2), a ramp 437 (as shown by ramp 437-1 in FIG. 4C for coupling feature 435-1 and ramp 437-2 in FIG. 4D for coupling feature 435-2), a running section 438 (as shown by running section 438-1 in FIG. 4C for coupling feature 435-1 and running section 438-2 in FIG. 4D for coupling feature 435-2), and a cradle 439 (as shown by cradle 439-1 in FIG. 4C for coupling feature 435-1 and cradle 439-2 in FIG. 4D for coupling feature 435-2).

The entry space 436 is at one end of the slot that forms the coupling feature 435, followed by the ramp 436, followed by the running section 438, and ending at the other end of the slot with the cradle 439. The entry space 436 is an opening that has a width that is large enough to allow a coupling feature 515 of the trim ring 110 to pass vertically (upward for coupling, downward for decoupling) therethrough. The entry space 436 of a coupling feature 435 is defined by a lack protrusions (e.g., a ramp 436, a running section 438, a cradle 439) along a vertical section of the collar 434.

Located to one side (in this case, the right side) of the entry space 436 of a coupling feature 435 is the ramp 437 of the coupling feature 435. The ramp 437 is a protrusion that acts as a transition to or from the running section 438 of the coupling feature 435. The ramp 437 is planar and positioned to form an obtuse angle at one end of the ramp 437 from the bottom of the collar 434 at the entry space 436 and an obtuse angle at the other end of the ramp 437 with the end of the running section 438 to which the ramp 437 adjoins. The ramp 437 is configured to guide a coupling feature 515 of the trim ring 110 from the entry space 436 toward the running section 438 as the trim ring 110 is coupled to the trim adapter 130 and from the running section 438 toward the entry space 436 as the trim ring 110 is decoupled from the trim adapter 130.

The running section 438 of a coupling feature 435 is a protrusion that extends outward from the collar 434 and has a top surface that is positioned parallel to the bottom of the collar 434. Both the ramp 437 and the running section 438 of a coupling feature 435 can have a height that extends vertically downward to the bottom of the collar 434. For each coupling feature 435, the distance between the top surface of each running section 438 and the top of the collar 434 is greater than the height of a coupling feature 515 of the trim ring 110. When the trim adapter 130 is coupled to the trim flange 121 of the flange 120, the bottom surface of the trim flange 121 acts as a boundary that limits the upward travel of the coupling features 515 of the trim ring 110 when positioned within the coupling features 435. While one end (in this case, the left end) of the running section 438 is adjoined to the ramp 437 of a coupling feature 435, the other end (in this case, the right end) of the running section 438 is adjoined to the cradle 439 of the coupling feature 435.

The cradle 439 of a coupling feature 435 is configured to retain a coupling feature 515 of the trim ring 110 when the trim ring 110 is coupled to the trim adapter 130. Each cradle 439 in this case is a recessed protrusion that is vertically offset downward (toward the distal end of the collar 434) relative to the running section 438 of a coupling feature 435. Specifically, the top surface of the cradle 439 is substantially planar with the bottom of the collar 434. One end (in this case, the left end) of the cradle 439 is formed by the right end of the running section 438 of a coupling feature 435, and the other end (in this case, the right end) of the cradle 439 is formed by a divider 431 (e.g., divider 431-2 for coupling feature 435-2 as shown in FIGS. 4C and 4D) of the coupling feature 435. The bottom portion of the cradle 439 is substantially parallel to the bottom of the collar 434 and has a width that is slightly larger than the width of a coupling feature 515 of a trim ring 110.

In this case, there is no overlap of the coupling features 435 in the vertical or horizontal plane of the collar 434 of the trim adapter 130. As a result, since there are three coupling features 435, the trim ring 110 only needs to be rotated less than 1200 to become fully coupled to or fully decoupled from the trim adapter 130. In alternative embodiments, there can be overlap between two or more coupling features 435. In such a case, the slots formed by each of the coupling features 435 can be configured similar to mating threads. As discussed above, the configuration of one or more of the coupling features 435 can differ (to include, for example, clamps, protruding tabs, and/or detents) from what is shown in FIGS. 3A through 4G and still allow the trim ring 110 to couple to and decouple from the trim adapter 130.

To couple the trim ring 110 to the trim adapter 130, the trim ring 110 is positioned below the trim adapter 130 so that the coupling features 515 of the trim ring 110 are disposed below the entry spaces 436. At that point, the trim ring 110 can be pushed upward so that the coupling features 515 pass through the entry spaces 436. Then, by rotating (e.g., clockwise) the trim ring 110 up the ramps 437, along the running sections 438, and toward the cradles 439, the trim ring 110 can be coupled to the trim adapter 130 by releasing the trim ring 110 downward so that the coupling features 515 are disposed in the cradles 439.

In optional embodiments, a retaining feature 375, as shown in FIGS. 3A and 3D, can be used to help retain a coupling feature 515 of the trim ring 110 within the cradle 439 of a coupling feature 435 of the trim adapter 130. A retaining feature 375 is configured to secure or retain a coupling feature 515 within the cradle 439 of a coupling feature 435 in the absence of a sufficiently large upward force applied to the trim ring 110. When an upward force of sufficient strength is applied to the trim ring 110 when the trim ring 110 is coupled to the trim adapter 130, then the trim ring 110 can overcome the downward force applied by the retaining features 375 to allow the bottom surface of the coupling features 515 to rise above the upper surface of the running section 438 of each coupling feature 435. This, in turn, allows for the trim ring 110 to be rotated in the opposite direction (e.g., counterclockwise) relative to coupling the trim ring 110 to the trim adapter 130 so that the trim ring 110 can be decoupled from the trim adapter 130.

Each retaining feature 375 can have any of a number of configurations and/or locations. In this case, there are three retaining features 375 (retaining feature 375-1, retaining feature 375-2, and retaining feature 375-3), where the retaining feature 375-1 is positioned above the cradle 439-1 of the coupling feature 435-1, the retaining feature 375-2 is positioned above the cradle 439-2 of the coupling feature 435-2, and the retaining feature 375-3 is positioned above the cradle 439-3 of the coupling feature 435-3.

In this case, each retaining feature 375 is a compressible and resilient device (e.g., a spring, a block of foam). A retaining feature 375 can be loosely disposed (e.g., not coupled to another component of the recessed luminaire 100) or coupled to another component (e.g., coupled to the bottom surface of the trim flange 121 of the trim 120, coupled to the outer surface of the collar 434 of the trim adapter 130) of the recessed luminaire 100. There can be any number of retaining features 375. For example, in this case, the number of retaining features 375 equals the number of coupling features 435 of the trim adapter 130.

Alternatively, there can a greater number of retaining features 375 or a lesser number of retaining features 375 relative to the number of coupling features 435 of the trim adapter 130. A coupling feature 435 of the trim adapter 130 can have no retaining features 375 or multiple retaining features 375. The number of retaining features 375 for one coupling features 435 of the trim adapter 130 can be the same as or different than the number of retaining features 375 of the other coupling features 435 of the trim adapter 130. In certain example embodiments, the trim adapter 130 also includes one or more of a number of securing member assemblies 425. In this case, there are four securing member assemblies 425 (securing member assembly 425-1, securing member assembly 425-2, securing member assembly 425-3, and securing member assembly 425-4). When there are multiple securing members assemblies 425, one securing member assembly 425 can have the same or a different configuration compared to the configuration of the other securing member assemblies 425. In this case, all four securing member assemblies 425 are configured identically with respect to each other. Each securing member assembly 425 can include one or more of a number of components. For example, in this case, each securing member assembly 425 includes a recessed feature 460 (such as the recessed feature 460-2 of the securing member assembly 425-2 of FIG. 4E) disposed in the body 433 of the trim adapter 130 and a securing member 465 (such as the securing member 465-2 of the securing member assembly 425-2 of FIGS. 4E through 4G).

Each securing member assembly 425 in this case is movably (e.g., rotatably) coupled to the body 433 of the trim adapter 130 at the recessed feature 460. The top surface of the body 433 of the trim adapter 130 is substantially planar, except for the recessed features 460. Each of the recessed features 460 is recessed below the upper surface of the body 433 of the trim adapter 130. Each recessed feature 460 (e.g., recessed feature 460-2) is configured to allow a securing member 465 (e.g., securing member 465-2) to become movably (in this case, hingedly) coupled to the body 433 of the trim adapter 130. Each recessed feature 460 in this case is similarly configured, although in alternative embodiments having multiple recessed features 460, one recessed feature 460 (e.g., recessed feature 460-2) can have one or more characteristics (e.g., shape, depth, size) that are different from the corresponding characteristics of another recessed feature 460.

In this example, each recessed feature 460 includes a body 461 and a coupling feature 462. For instance, as shown in FIG. 4E, recessed feature 460-2 includes a body 461-2 and a coupling feature 462-2. The body 461-2 in this case is planar and substantially parallel to the upper surface of the body 433 of the trim adapter 130, although in alternative embodiments, the body 461-2 of the recessed feature 460-2 can have any of a number of other features and/or configurations relative to what is shown in FIG. 4E. For example, the body 461-2 can have straight edges, have ridges, and/or be made of a different material (e.g., rubber rather than aluminum) compared to the material of the body 433 of the trim adapter 130.

The space formed above the body 461-2 of the recessed feature 460-2 is sufficient to house an independent coupling feature 470 (e.g., coupling feature 470-2, as shown in FIG. 4E) of the securing member 465-2 so that the coupling feature 470 does not extend above a planar extension of the upper surface of the body 433 of the trim adapter 130. In this example, the coupling feature 470-2 is disposed in the coupling feature 462-2 disposed in the body 461-2 and acts as a hinge to allow for rotation of the coupling body 466-2 of the securing member 465-2 around a vertical axis formed by the coupling feature 470-2.

The coupling feature 462-2 of the recessed feature 460-2 is configured to allow the recessed feature 460-2 to couple, directly or indirectly, to the securing member 465-2 of the securing member assembly 425-2 while also allowing the securing member 465-2 to rotate relative to the recessed feature 460-2. The coupling feature 462-2 in this example is in the form of an aperture that traverses the body 461-2 so that the independent coupling feature 470-2 (in this case, in the form of a rivet) can be disposed therein. The position of the coupling feature 462-2 is centered within the body 461-2. In any case, the coupling feature 462-2 of the recessed feature 460-2 is configured to complement the coupling feature 467-2 of the securing member 465-2 so that the securing member 465-2 can be movably coupled to the recessed feature 460-2.

In certain example embodiments, the securing member 465-2 of the securing member assembly 425-2 is configured to retain multiple components (e.g., the trim flange 121 of the trim 120, the body 433 of the trim adapter 130) in a substantially fixed position relative to each other. The securing member 465-2 can have any of a number of configurations. For example, in this case, the securing member 465-2 is a C-shaped bracket or spring clip having a back wall 463-2, a top wall 469-2 that extends from the top of the back wall 463-2, and a bottom wall 468-2 that extends from the bottom of the back wall 463-2. The securing member 465-2 in this example also includes a control feature 464-2 that extends from one end of the back wall 463-2 and the coupling body 466-2 (along with the coupling feature 467-2) that is disposed on the opposite end of the back wall 463-2 relative to the control feature 464-2. In this spring clip configuration, the top wall 469-2 and the bottom wall 468-2 are substantially parallel with each other and apply a compressive force toward each other.

The back wall 463-2, the top wall 469-2, and the bottom wall 468-2 of the securing member 465-2 can be formed from a single piece or from multiple pieces that are coupled to each other. In either case, the top wall 469-2 and/or the bottom wall 468-2 can be resiliently flexible with respect to the back wall 463-2. In other words, the distance between the top wall 469-2 and the bottom wall 468-2 can be temporarily expanded so that one or more components (e.g., the trim flange 121 of the trim 120, the body 433 of the trim adapter 130) can be disposed within the space formed between the back wall 463-2, the top wall 469-2, and the bottom wall 468-2. Subsequently, distance between the top wall 469-2 and the bottom wall 468-2 can be decreased toward a default position in a manner that the other components of the recessed luminaire 100 are retained therein.

In certain example embodiments, the control feature 464-2 is configured to allow a user to rotate or otherwise move, without the use of a tool, the securing member 465-2 so that the securing member 465-2 engages with and/or disengages from the trim flange 121 of the trim 120 and/or the body 433 of the trim adapter 130. In this case, the control feature 464-2 is an extension of one side of the back wall 463-2 that is bent backward (away from the direction in which the top wall 469-2 and the bottom wall 468-2 extend) at a slight angle relative to the back wall 463-2. In alternative embodiments, the control feature 464-2 can be a separate piece that is mechanically coupled to the back wall 463-2 and/or have any of a number of other configurations that can allow a user to move the securing member 465-2 relative to the trim adapter 130, with or without the use of a tool.

The coupling body 466-2 and the associated coupling feature 467-2 of the securing member 465-2 are configured to allow the securing member 465-2 to be movably (in this case, rotatably) coupled to the body 433 of the trim adapter 130. The coupling body 466-2 and the coupling feature 467-2 can have any of a number of characteristics and configurations. For example, in this case, the coupling body 466-2 is a planar section that extends from the back wall 463-2 and is substantially planar with at least part of the bottom wall 468-2. In this case, the coupling body 466-2 and the back wall 463-2 can be formed from a single piece, but in alternative embodiments they are separate pieces that are mechanically coupled to each other. In some cases, the coupling body 466-2 and the coupling feature 467-2 are omitted from the securing member 465-2.

As discussed above, the coupling feature 467-2 in this case is an aperture that traverses the coupling body 466-2 and is configured to receive an independent coupling feature 470-2 (e.g., a rivet (as in this example), a screw, a hinge). In alternative embodiments, the coupling feature 467-2 is configured to provide direct coupling to the body 433 of the trim adapter 130. The location of the coupling feature 467-2 in the coupling body 466-2 in this case is in the approximate center to provide stability and allow for unobstructed rotation of the securing member 465-2 with respect to the other components (e.g., the trim flange 121 of the trim 120, the body 433 of the trim adapter 130) that are disposed within the space formed by the back wall 463-2, the top wall 469-2, and the bottom wall 468-2 at the time.

The top surface of the coupling body 466-2 of the securing member 465-2 is configured to movably (e.g., rotatably, slidably) abut against the bottom surface of the body 433 of the trim adapter 130. Further, the coupling feature 467-2 of the securing member 465-2 is configured to complement (in this case, align with) the coupling feature 462-2 of the recessed feature 460-2. The size (e.g., length, width, height) of the recessed feature 460-2 is configured to be sufficient to allow the coupling feature 470-2 to be disposed in the space between the top of the body 461-2 of the recessed feature 460-2 and the top surface of the body 433 of the trim adapter 130.

In certain example embodiments, the trim ring 110 has any of a number of configurations and/or includes one or more of a number of features. For example, the trim ring 110 of FIGS. 5A through 5D has a body 511, a collar 513 disposed at the top end of the body 511, and a decorative trim portion 512 disposed at the bottom end of the body 511. The body 511, the collar 513, and the decorative trim portion 512 can be formed from a single piece or from multiple pieces that are coupled to each other. The body 511 (sometimes called the trim ring body 511), the collar 513 (sometimes called the trim ring collar 513), and the decorative trim portion 512 collectively form a cavity 517 through their center. In this case, the body 511 of the trim ring 110 is substantially conically shaped, but in alternative embodiments, the body 511 can have any of a number of other shapes (e.g., cylindrical, triangular prism, cubic).

Also, as discussed above, the trim ring 110 includes multiple (in this case, three) coupling features 515 that are configured to couple to complementary coupling features (in this case, the coupling features 435) of the trim adapter 130. The number, spacing, configuration (e.g., shape, size), and other characteristics of the coupling features 515 (sometimes called trim adapter coupling features 515) can be configured to complement the corresponding characteristics of the coupling features 435 of the trim adapter 130. In this case, the three coupling features 515 (coupling feature 515-1, coupling feature 515-2, and coupling feature 515-3) are rectangular prisms that extend laterally outward from the collar 513 of the trim ring 110. The coupling features 515 can be distributed around the collar 513 in any manner (e.g., substantially equidistantly (as in this case), randomly) with respect to each other. The number of coupling features 515 can be equal to or different than (e.g., less than) the number of coupling features 435 of the trim adapter 130.

In certain example embodiments, as in this case, there is no single orientation that the trim ring 110 must have with respect to the trim adapter 130 in order for the trim adapter 130 and the trim ring 110 to become coupled to each other. Specifically, the trim ring 110 can have 3 discrete orientations with respect to the trim adapter 130 in order for the trim adapter 130 and the trim ring 110 to become coupled to each other. In one orientation, the coupling feature 515-1 engages with the coupling feature 435-1, the coupling feature 515-2 engages with the coupling feature 435-2, and the coupling feature 515-3 engages with the coupling feature 435-3. In a second orientation, the coupling feature 515-2 engages with the coupling feature 435-1, the coupling feature 515-3 engages with the coupling feature 435-2, and the coupling feature 515-1 engages with the coupling feature 435-3. In the third orientation, the coupling feature 515-3 engages with the coupling feature 435-1, the coupling feature 515-1 engages with the coupling feature 435-2, and the coupling feature 515-2 engages with the coupling feature 435-3.

In alternative embodiments, the orientation of the coupling features 515 of the trim ring 110 and/or the coupling features 435 of the trim adapter 130 can allow for only a single orientation of the trim ring 110 relative to the trim adapter 130 in order to allow for the trim ring 110 to become coupled to the trim adapter 130. In such cases, the orientation of the trim ring relative to the trim adapter 130 can be determined using, for example, the distribution of the coupling features 515 and/or the coupling features 435, a different configuration of one coupling feature 515 relative to the other coupling features 515, and a different configuration of one coupling feature 435 relative to the other coupling features 435. In addition, or in the alternative, the trim ring 110 and/or the trim adapter 130 can include one or more features (e.g., a key in the form of a protrusion, a key receiver in the form of a recess) that require one or more particular orientations of the trim ring 110 relative to the trim adapter 130 in order to allow for the trim ring 110 to become coupled to the trim adapter 130.

In certain example embodiments, the trim adapter 130 and the trim ring 110 can be coupled to each other and/or decoupled from each other without the use of tools (e.g., a screwdriver, a wrench). In some cases, the trim adapter 130 and the trim ring 110 can be coupled to each other and/or decoupled from each other independent of whether the trim adapter 130 is coupled to the trim 120 (or some other component) of the recessed luminaire 100. In such a case, as an example, if the trim adapter 130 of the detachable trim accessory assembly 150 is coupled to the trim flange 122 of the trim 120, a user can decouple the trim ring 110 from the trim adapter 130 while the trim adapter 130 remains coupled to the trim flange 121 of the trim 120. Similarly, if the trim adapter 130 of the detachable trim accessory assembly 150 is coupled to the trim flange 121 of the trim 120, a user can couple the trim ring 110 to the trim adapter 130 while the trim adapter 130 remains coupled to the trim flange 121.

In addition, the trim adapter 130 and the trim ring 110 can be coupled to each other and/or decoupled from each other independent of whether the remainder of the recessed luminaire 100 is installed relative to a structure 109 and regardless of whether the trim adapter 130 is coupled to the trim flange 121 of the trim 120. Further, if the trim ring 110 is decoupled from the trim adapter 130, the trim adapter can be coupled to and/or decoupled from the trim flange 122 of the trim 120 while the recessed luminaire 100 is installed relative to the structure 109.

The decorative trim portion 512 of the trim ring 110 is the predominant portion of the recessed luminaire 100 that is visible to a user located within the volume of space 138. In certain example embodiments, the decorative trim portion 512 can have any of a number of characteristics (e.g., color, shape, material, size) to satisfy aesthetic goals. In addition, or in the alternative, the decorative trim portion 512 can be configured to have one or more optical features (e.g., reflectors, refractors) that allow the decorative trim portion 512 to help manipulate (e.g., reflect, refract, change color, change temperature) light emitted by light sources of the recessed luminaire 100 into the volume of space 138.

In certain example embodiments, because the coupling features 515 of the trim ring 510 are engaged with the coupling features 435 of the trim adapter 430 below the structure 109 within the volume of space 138 (and so could possibly be seen by users), and similarly because the securing member assemblies 425 of the trim adapter 430 are engaged with the trim flange 121 of the trim 120 (or other component of the recessed luminaire 100) below the structure 109 within the volume of space 138 (and so could possibly be seen by users), the decorative trim portion 512 and/or the trim body 511 of the trim ring 510 can be designed in such a way that the coupling features 435, the coupling features 515, and the securing member assemblies 425 can be hidden from view in the volume of space 138.

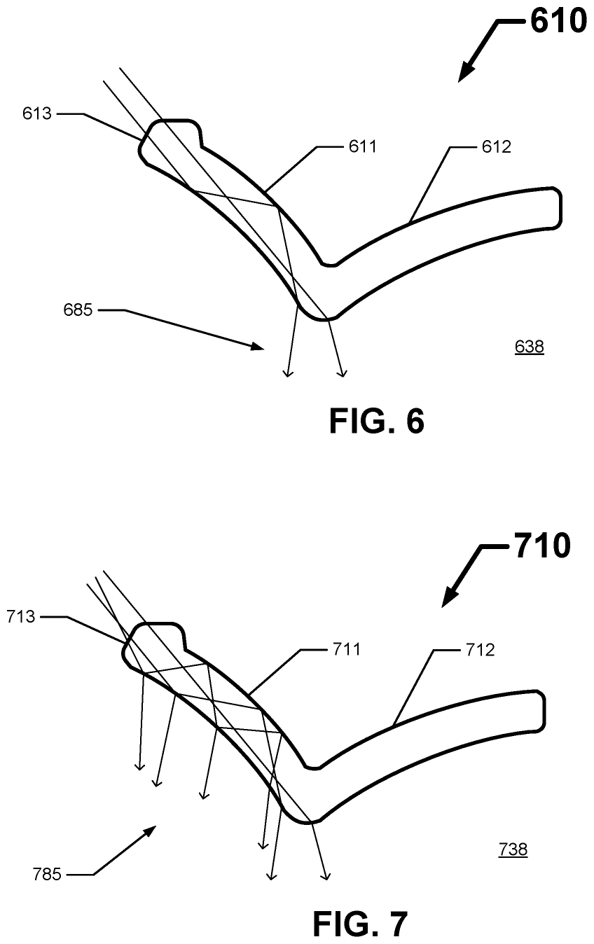

For example, the trim body 511 of the trim ring 510 can be made of an opaque material. As another example, the trim body 511 can be made, at least in part, of a translucent material where light is distributed therethrough in such a way that hides the coupling features 435, the coupling features 515, and the securing member assemblies 425. FIGS. 6 and 7 show light distributions of light emitted by a light source (e.g., light source 107) within various trim rings according to example embodiments. Specifically, FIG. 6 shows a light distribution 685 through a section of a trim ring 610. FIG. 7 shows a light distribution 785 through a section of a trim ring 710. The shape and size of the trim ring 610 and the trim ring 710 are substantially the same as the trim ring 110 discussed above with respect to FIGS. TA through 5D, but the properties (e.g., reflective, refractive) of the surfaces and/or the inner composition of the trim ring 610 and the trim ring 710 are varied relative to those of the trim ring 110.

Referring to FIGS. TA through 7, in the trim ring 610 of FIG. 6, some of the light rays emitted by a light source pass into the collar 613 and/or the top of the trim body 611 of the trim ring 610. The inner surfaces of the walls of the trim body 611 can be made of and/or coated with a reflective material that channels all of the light to the distal end of the trim body 611 and pass through the trim ring 610 where the trim body 611 transitions to the decorative trim portion 612, resulting in the light distribution 685 shown in FIG. 6. The decorative trim portion 612 in this case is opaque, and so no light is emitted therethrough. This light distribution 685 is sufficient to prevent the coupling features (not shown, but substantially similar to the coupling features 515 discussed above) of the trim ring 610, the coupling features 435 of the trim adapter 430, and the securing member assemblies 425 of the trim adapter 430 from being viewed by a user within the volume of space 638.

In the trim ring 710 of FIG. 7, some of the light rays emitted by a light source pass into the collar 713 and/or the top of the trim body 711 of the trim ring 710. The inner surface of the wall of the trim body 711 in the volume of space 738 can be made of and/or coated with a refractive material that directs some of the light through the inner wall of the trim body 711 while reflecting the remainder, while the inner surface of the opposite wall of the trim body 711 can be made of and/or coated with a reflective material. This configuration of the trim body 711 results in the light distribution 785 shown in FIG. 7. The decorative trim portion 712 in this case is opaque, and so no light is emitted therethrough. This light distribution 785 is sufficient to prevent the coupling features (not shown, but substantially similar to the coupling features 515 discussed above) of the trim ring 710, the coupling features 435 of the trim adapter 430, and the securing member assemblies 425 of the trim adapter 430 from being viewed by a user within the volume of space 738 when the recessed luminaire 100 is illuminated.

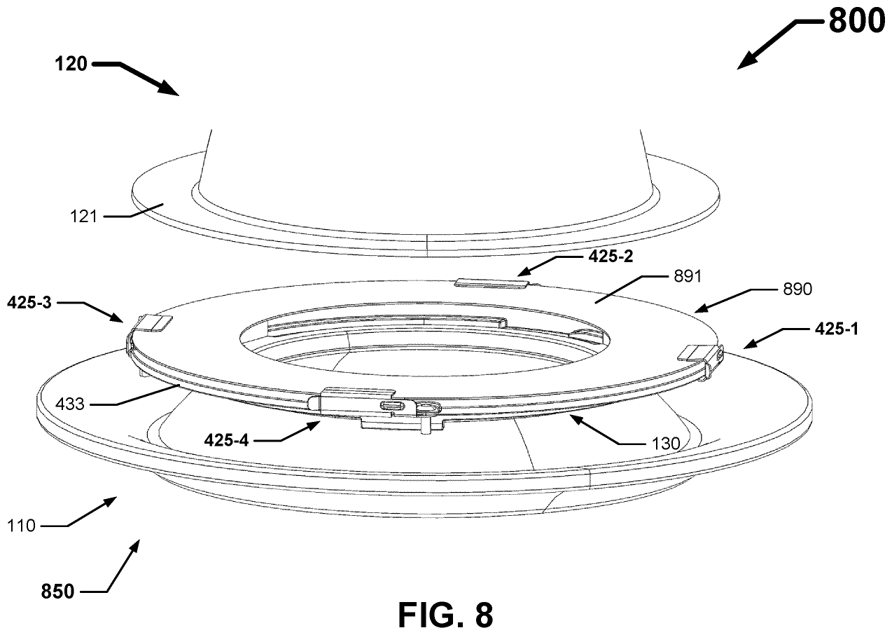

FIG. 8 shows part of a recessed luminaire 800 that includes another detachable trim assembly 850 according to certain example embodiments. Referring to FIGS. TA through 8, the part of the recessed luminaire 800 shown in FIG. 8 includes the detachable trim assembly 850 isolated from the bottom part of the trim 120 of FIGS. TA through 2C. The detachable trim assembly 850 includes the trim adapter 130 and the trim ring 110 of the recessed luminaire 100, as well as a spacer 890 disposed atop the body 433 of the trim adapter 130. The trim adapter 130 and the trim ring 110 are coupled to each other as discussed above with respect to FIGS. 3A through 5D.

The spacer 890 in this case is configured to occupy space within the securing members (e.g., securing members 465) of the securing member assemblies 425 (in this case, securing member assembly 425-1, securing member assembly 425-2, securing member assembly 425-3, and securing member assembly 425-4). By adding the thickness of the spacer 890 to the thickness of the body 433 of the trim adapter 130 and the thickness of the trim flange 121 of the trim 120, when all three are disposed within the securing members of the securing member assemblies 425, the securing members are under greater tension, and so can more securely hold the spacer 890, the trim flange 121 of the trim 120, and the body 433 of the trim adapter 130 in place without allowing the trim adapter 130 to rotate relative to the trim 120 as the trim ring 110 is coupled to and/or decoupled from the trim adapter 130.

The spacer 890 is an optional component of the detachable trim assembly 850. The spacer can have any of a number of configurations (e.g., shape, thickness, width). In this case, the spacer 890 is toroidal in shape with a relatively small thickness. Also, the inner diameter and the outer diameter of the spacer 890 is substantially the same as the inner diameter and the outer diameter, respectively, of the body 433 of the trim adapter 130.

Example embodiments can be used to allow a user to install, remove, and/or change one or more decorative trim components of a recessed light fixture when the recessed light fixture is installed with respect to a structure (e.g., a ceiling) more easily. Example decorative and detachable trim accessory assemblies (or portions thereof) can be installed, removed, and/or changed from a recessed luminaire (or any other type of luminaire) without the use of a tool (e.g., a screwdriver, a wrench), even if the recessed luminaire is installed (e.g., in a ceiling). Example embodiments can also provide flexibility as to the aesthetic appeal of the trim and/or in how light emitted by the recessed luminaire can be manipulated and/or distributed. Example embodiments can be used with recessed luminaires having any of a number of mounting systems and features. Example embodiments can be used in new installations of recessed luminaires as well as retrofitting or replacing a portion of the trim for existing luminaires. Example embodiments also provide a number of other benefits. Such other benefits can include, but are not limited to, increased ease of maintenance, greater ease of use, and compliance with industry standards that apply to luminaires.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A detachable trim accessory assembly for a luminaire, the detachable trim accessory comprising:
a trim adapter comprising a trim collar and a plurality of trim ring coupling features disposed on the trim collar;
a trim ring comprising a trim ring collar and a plurality of trim adapter coupling features disposed on the trim ring collar, wherein the plurality of trim adapter coupling features are removably coupled to the plurality of trim ring coupling features of the trim adapter, and
wherein the trim adapter further comprises a trim adapter body and a plurality of securing member assemblies disposed on the trim adapter body, wherein each of the plurality of securing member assemblies, is configured to secure the trim adapter body against a trim flange of the luminaire, and wherein each of the plurality of trim ring securing member assemblies comprises a securing member that is a spring clip, wherein the spring clip has a top wall and a bottom wall that are substantially parallel with each other, and wherein the spring clip is moveable relative to the trim adapter in one position to engage, or another position to disengage, with the trim flange; and
wherein each of the plurality of trim adapter coupling features comprises a protruding tab, wherein each of the plurality of trim ring coupling features comprises a slot having a first end and a second end, wherein the first end receives the protruding tab into the slot, and wherein the second end comprises a cradle that retains the protruding tab.

2. The detachable trim accessory assembly of claim 1, wherein each of the plurality of securing member assemblies is configured to be removably secured to the trim flange of the luminaire without use of tools.

3. The detachable trim accessory assembly of claim 1, wherein the plurality of trim ring coupling features and the plurality of trim adapter coupling features are detachably coupled to each other without using tools.

4. (canceled)

5. The detachable trim accessory assembly of claim 41, wherein the trim ring is rotated less than 90° for each of the plurality of trim adapter coupling features to travel between the first end and the second end of each slot of the plurality of trim ring coupling features.

6. The detachable trim accessory assembly of claim 41, wherein when the protruding tab of each of the plurality of trim adapter coupling features is retained by the cradle at the second end of each slot of the plurality of trim ring coupling features, the trim ring is pushed toward the trim flange of the luminaire and rotated toward the first end of each of slot of the plurality of trim ring coupling features to remove the trim ring.

7. The detachable trim accessory assembly of claim 6, wherein the trim adapter remains coupled to the trim flange of the luminaire when the trim ring is removed.

8. The detachable trim accessory assembly of claim 1, wherein the trim ring comprises a trim ring body that hides the plurality of trim adapter coupling features, the plurality of trim ring coupling features, and the plurality of trim ring securing member assemblies from being seen from a volume of space in which light emitted from a light source of the luminaire is directed.

9. The detachable trim accessory assembly of claim 8, wherein a portion of the light emitted from the light source is directed through the trim ring body into the volume of space.

10. The detachable trim accessory assembly of claim 1, wherein each of the plurality of trim ring securing member assemblies is rotatably coupled to the trim adapter body.

11. A luminaire comprising:
a trim comprising a trim body and a trim flange, wherein the trim flange is disposed at a distal end of the trim body; and
a detachable trim accessory assembly removably coupled to the trim, wherein the detachable trim accessory assembly comprises a trim adapter comprising a trim adapter body and a plurality of securing member assemblies disposed on the trim adapter body, wherein each of the plurality of securing member assemblies is configured to secure the trim adapter body against the trim flange, wherein each of the plurality of trim ring securing member assemblies comprises a securing member that is a spring clip, wherein the spring clip has a top wall and a bottom wall that are substantially parallel with each other, and wherein the spring clip is moveable relative to the trim adapter in one position to engage, or another position to disengage, with the trim flange; and wherein the detachable trim accessory assembly further comprises a trim ring having a trim ring collar and a plurality of trim adapter coupling features disposed on the trim ring collar, wherein each of the plurality of trim adapter coupling features comprises a protruding tab, and wherein the plurality of trim adapter coupling features are removably coupled to a plurality of trim ring coupling features of the trim adapter, wherein each of a plurality of trim ring coupling features comprises a slot having a first end and a second end, wherein the first end receives the protruding tab into the slot, and wherein the second end comprises a cradle that retains the protruding tab.

12. (canceled)

13. The luminaire of claim 11, wherein the trim flange and the detachable trim accessory assembly are disposed below a ceiling within a volume of space separate from another volume of space in which a remainder of the luminaire is disposed.
